(19) United States
(12) Patent Application Publication
(10) Pub. No.: US 2014/0059675 A1
(43) Pub. Date: Feb. 27, 2014

(54) BIOMETRIC AUTHENTICATION

(71) Applicants: RAYTHEON COMPANY, Waltham, MA (US); NOVA SOUTHEASTERN UNIVERSITY, Fort Lauderdale, FL (US)

(72) Inventors: Robert B. BATIE, JR., Fort Lauderdale, FL (US); Yair LEVY, Fort Lauderdale, FL (US)

(73) Assignees: RAYTHEON COMPANY, Waltham, MA (US); NOVA SOUTHEASTERN UNIVERSITY, Fort Lauderdale, FL (US)

(21) Appl. No.: 13/975,534

(22) Filed: Aug. 26, 2013

Related U.S. Application Data
(60) Provisional application No. 61/692,981, filed on Aug. 24, 2012.

(51) Int. Cl. G06F 21/32

(52) U.S. Cl. CPC G06F 21/32
USPC 726/19

(57) ABSTRACT

A method of authenticating a user includes using at least one computer and connected scanner to obtain biometric measurements of a plurality of biometric parameters of the user. The parameters are stored as templates for comparison, as well as a sequence in which the plurality of biometric parameters are to be scanned in order to perform a valid authentication. Authentication is determined by comparing each biometric parameter submitted with the stored biometric templates, to determine if each biometric parameter matches a stored template. In addition, the sequence with which each matched template was presented is identified, and this sequence is compared with the stored sequence. If a predetermined number of biometric parameters match, and a predetermined number of elements in a sequence match, the user is authenticated.

### CROSS REFERENCE TO RELATED APPLICATIONS

This application claims the benefit of related U.S. Patent Application No. 61/692,981, filed Aug. 24, 2012, the contents of which are incorporated herein by reference in their entirety.

### FIELD OF THE INVENTION

The invention relates to a system and method for authenticating a user, and more particularly to authentication using biometric parameters.

### BACKGROUND OF THE INVENTION

Traditional user authentication methods such as user identification (userID) and passwords still pose a significant vulnerability when accessing information systems (Pinkas & Sander, 2002). The problem has become more acute as Internet use grows and fraudulent strategies are launched daily in efforts to exploit the lack of adequate Internet authentication (Shenk, 2007). Authentication is a way to identify, establish, verify, and prove the validity of a claimed identity of a user, process, or system (Hermann, 2002).

### SUMMARY OF THE INVENTION

In accordance with an embodiment of the disclosure, a method of authenticating a user comprises using at least one computer and connected scanner to obtain biometric measurements of a plurality of biometric parameters of the user; storing the biometric measurements upon computer readable media as templates for comparison; storing upon computer readable media a sequence in which the plurality of biometric parameters are to be scanned in order to perform a valid authentication; determine authentication of the user by using at least one computer to—compare biometric parameters submitted with the stored biometric templates, to determine if biometric parameters match a stored template, identify the sequence with which each biometric parameter was presented, compare the sequence with the stored sequence, and if a predetermined number of biometric parameters match, and a predetermined number of sequences match, authenticate the user.

In various embodiments thereof, the biometric parameter is a finger or thumbprint; the biometric parameter includes a measurement of finger segments; the biometric parameter is a part of an eye.

In another embodiment of the disclosure, a system of authenticating a user, comprises at least one computer connectable to a scanner configured to obtain biometric measurements of a plurality of biometric parameters of the user; software executable from non-transitory media by said at least one computer operative to—(a) store the biometric measurements upon computer readable media as templates for comparison; (b) store upon computer readable media a sequence in which the plurality of biometric parameters are to be scanned in order to perform a valid authentication; (c) determine authentication of the user by—(i) comparing each biometric parameter submitted with the stored biometric templates, to determine which biometric parameters match a stored template, (ii) identifying the sequence with which each biometric parameter was presented, (iii) comparing the sequence with the stored sequence, and (iv) if a predetermined number of biometric parameters match, and a predetermined number of sequences match, authenticate the user.

In various embodiments thereof, the biometric parameter is a finger or thumbprint; the biometric parameter includes a measurement of finger segments; the biometric parameter is a part of an eye.

In yet another embodiment of the disclosure, a method of authenticating a user, comprises using software executing upon at least one computer, the software stored on non-transitory media and configured to: receive data pertaining to a plurality of biometric parameters each corresponding to a different body part of an individual to be authenticated; receive template data pertaining to a selection of the plurality of biometric parameters for a user to be authenticated; receive sequence data pertaining to a sequential order in which the selection of the plurality of biometric parameters are to be presented for authentication by the user; receive biometric presentation data pertaining to biometric data corresponding to a plurality of body parts presented by the user during an attempt to authenticate the user; receive sequence presentation data pertaining to a sequence in which the plurality of body parts were presented by the user; compare the biometric data to the template data to determine a quantity of presented body parts which match biometric parameters of the stored template; compare the sequence presentation data to the sequence data to determine a quantity of body parts presented in the sequential order of the sequence data; and indicate authentication if the quantity of the biometric data comparison and the quantity of the sequence presentation comparison are within a predetermined range.

In various embodiments thereof, data pertaining to a plurality of biometric parameters are received for a plurality of individuals; each biometric parameter in the template data is assigned a predetermined weight; each biometric parameter in the sequential order of the sequence data is assigned a predetermined weight; authentication is indicated in accordance with the formula:

R·wᵣ+S·wₛ>M

where wᵣ+wₛ≦1, and R corresponds to a total percentage value corresponding to correct biometric readings, S corresponds to a total percentage value corresponding to elements presented in the correct sequence, and M corresponds to a predetermined threshold for indicating authentication.

In further embodiments thereof, authentication is indicated in accordance with at least one of a linear and non-linear algorithm using the quantity of the biometric data comparison and the quantity of the sequence presentation comparison; authentication is indicated in accordance with a non-linear regression algorithm using the quantity of the biometric data comparison and the quantity of the sequence presentation comparison; the quantity of the biometric data comparison is adjusted using a weighting algorithm; the quantity of the sequence presentation comparison is adjusted using a weighting algorithm; the predetermined range is calculated by independently weighting each of the quantity of the biometric data comparison and the quantity of the sequence presentation comparison; the predetermined range is calculated by independently weighting each value of the biometric data comparison and each value of the sequence presentation comparison.

In an additional embodiment thereof, the predetermined range is calculated by independently weighting each of the quantity of the biometric data comparison and the quantity of the sequence presentation comparison; the predetermined range is calculated according to the formula: R·wᵣ+S·wₛ>M where wᵣ+wₛ≦1, and R corresponds to the total of all weighted biometric data, S corresponds to the total of all weighted sequence data, and M corresponds to a predetermined threshold for indicating authentication.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a hand of a user, illustrating fingerprint and finger segment regions which may be scanned in accordance with the disclosure;

FIG. 2 illustrates a PRIOR ART scanner for scanning a fingerprint region;

FIG. 3 illustrates regions of a fingerprint which are advantageously analyzed in accordance with the disclosure; and

FIG. 4 is a diagram of an exemplary stored BIO-PIN sequence template in accordance with the disclosure, illustrating weights applied to each of the collective biometric and sequential results;

FIG. 5 is a diagram of an authentication entry, evaluated against the stored sequence in FIG. 4, illustrating weighting applied to individual biometric and sequential entries, the third and fourth sequential entries not matching the stored template;

FIG. 6 is a diagram of an authentication entry, evaluated against the stored sequence in FIG. 4, illustrating weighting applied to individual biometric and sequential entries, the fourth sequential entry not matching the stored template; and

FIG. 7 illustrates a computing device and architecture which may be used in carrying out the disclosure.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

Authentication may be performed using one or more of the following methods: (1) providing something one knows, for example a password or personal identification number (PIN), (2) providing something one possesses (a token, fob, or card), and/or (3) providing a personal attribute as a biometric parameter, for example a fingerprint, hand or finger measurement, a face pattern, a voice sample, venial patterns, or an iris image. (Hisham, Harin, & Sabah, 2010). In accordance with the disclosure, each of these approaches lends itself to shortcomings, whereby traditional methods of authentication are inadequate.

The disclosure provides a multi-factor biometric personal identification and authentication method and apparatus which uses a fingerprint, and/or other biometric parameter, as a multi-factor and multi-biometric authentication mechanism. In accordance with the disclosure, in an example of fingerprints used as the biometric parameter, the fingerprints of the user are presented to an information system in a specific sequence for authentication, hereinafter termed the BIO-PIN sequence. The sequence that the fingerprints are presented to the authentication mechanism is assumed to be known, and is advantageously only known, to the user submitting the fingerprints in sequence.

In accordance with the disclosure, to form a stronger and more reliable authentication, a plurality of fingerprints (or other biometric parameters) are presented by the user for machine reading in a particular sequence, whereby the fingerprint pattern and the sequence are both used to authenticate the user (herein BIO-PIN), and must both match a fingerprint or other body part template (BIO) and a predetermined sequence (PIN). Thus, in accordance with the disclosure, a method of authentication includes presenting fingerprints, or other biometric, for example retinal scan, in a specific sequence. Additionally, in accordance with the disclosure, a biometric scanner is provided capable of processing the particular biometric parameter at a sufficient speed, whereby the user may introduce each biometric reading at a convenience pace, for example at a fraction of a second, to several second intervals. Additionally, the disclosure provides a computing subsystem which can compare the readings with a template, and validate the sequence, either in real-time or near real-time, for example to permit access to a resource when the user is waiting, or at a slower rate, for example where accesses by users are periodically audited.

In an embodiment of the disclosure, a computer stores information pertaining to the biometric parameter presented as a data template, and also stores the sequence in which each template was presented. Later, during authentication, a computer compares new biometric parameters presented against the data template for each parameter presented, and once matches are found for each, compares the sequence of the matched parameters with the original presentation. If the parameters later presented match the data template within a predetermined tolerance, and the sequence later presented matches the sequence originally presented, the computer will indicate an acceptance or take some other useful action. It should be understood that the tolerance of the match, and whether a complete and exact sequence is required, may be determined based upon the needs of a particular identification or authentication application.

Further in accordance with the disclosure, the False Acceptance Rate (FAR) threshold for a poor quality image template is reduced by the introduction of the correct BIO-PIN sequence, and therefore a poor quality image may more often still be used for proper authentication. Further the FAR threshold, or the closeness with which the biometrics reading and the template must match, may advantageously be relaxed or broadened by the introduction of a correct BIO-PIN sequence. In either or both cases, a poor quality template can be used as part of an authentication that may ultimately be considered more reliable.

Similarly, in accordance with the disclosure, a False Reject Rate (FRR) is reduced by the introduction of the BIO-PIN sequence. A poor quality template, when used in conjunction with the BIO-PIN sequence, is less likely to produce a false reject than the use of a poor quality template alone.

In accordance with the disclosure, the inventors have found there is a significant improvement in a user remembering a unique BIO-PIN sequence over, for example, a six week period, than remembering an industry standard, best practice user-ID and password. More particularly, there is, at least, less information that must be memorized using a method and apparatus of the disclosure, and additionally, the use of fingers may introduce a natural mnemonic for many people. It is further found, therefore, that a user is more likely to remember the BIO-PIN sequence for a longer period of time, for example, every two weeks, for a six week interval, than a strong industry standard, best practice user-ID and password.

Further in accordance with the invention, the inventors found that improvements in remembering a BIO-PIN sequence will be realized for all ages, genders, computing experience, as compared to remembering a user ID and password, for example over a two week, or six week period. It should be understood that a best practice user-ID and password include values which are hard to guess or determine, and are thus harder to remember. However, the inventors have found that a BIO-PIN sequence may be easier to remember than even a user-ID and password that contain common terms, or values familiar to the user.

Moreover, in accordance with the disclosure, a unique pattern or sequence of biometric readings, or different BIO-PINs, may be provided for each of a plurality of different accounts or access points. Further, a biometric reading may be repeated within a sequence. For example, a ring finger may be measure twice, followed by a pinky, then a thumb, or any combination of fingers, of either hand. In another embodiment, different types of biometric parameters may be mixed, for example a left eye reading may be followed by either or both of a right eye reading, or a thumb reading.

In accordance with yet another aspect of the invention, the BIO-PIN combines something a user possesses (BIO) and something a user knows (PIN). In this manner, the security of personal authentication is increased, while a user is required to remember less.

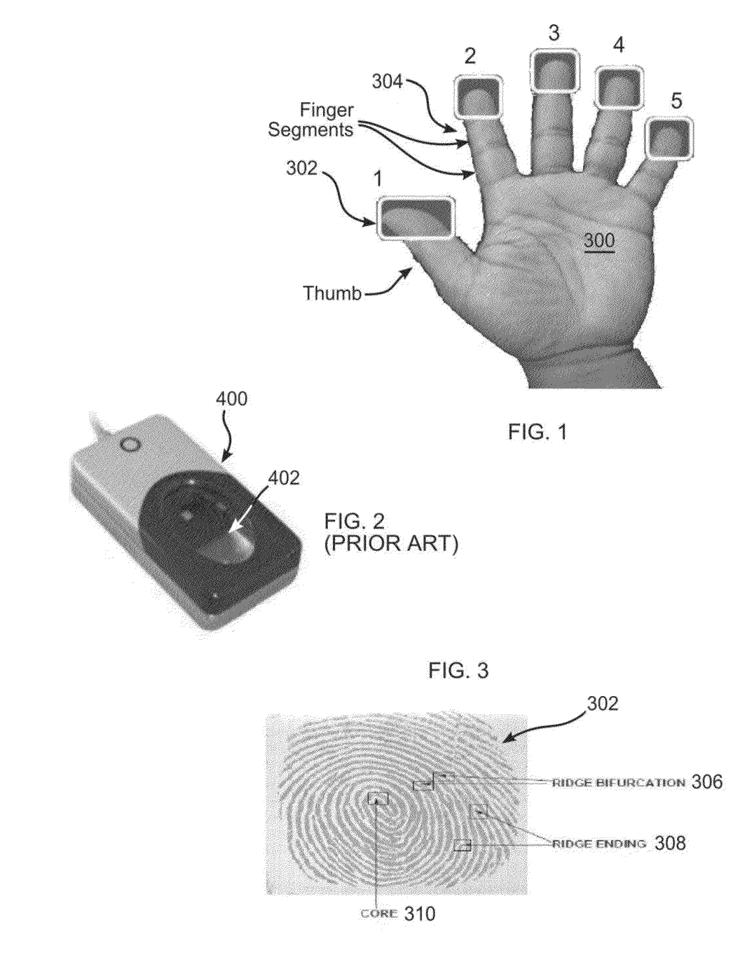

With reference to FIG. 1, a hand 300 is illustrated, showing fingerprint areas 302, identified with a bounding box, which are advantageously read, or scanned, by a scanner, for example a diode/CCD or capacitive scanner, for example as shown as device 400 of FIG. 2. The body part to be scanned in the example of FIG. 2 is passed over a slot 402 to be read. Other scanners (not shown), may scan a range of a user's body while the user remains motionless, for example in a retinal scanner. The scanner advantageously provides results of the scan to a computing device as digital data for matching against a template. The computing device then indicates authorization or not to a subsystem, for example a locking device, or a software subroutine for granting or denying access to a location or resource, or stores the result for later processing. The ridges and valleys of the unique fingerprint pattern are compared with a pattern stored previously of the user's fingerprint areas. In accordance with the disclosure, a plurality of fingerprint areas are scanned in a particular sequence, and the sequence must match a previously stored sequence associated with the user. Each fingerprint area scanned in the sequence must match the fingerprint area associated with the fingerprint area previously identified to be associated with the particular order in the sequence. In another embodiment of the disclosure, finger segments 304 are also scanned and analyzed as part of the scanned areas to be associated with each scan in a sequence. Other body parts may be substituted, provided each such body part may be uniquely identified with respect to like body parts of other users of a security system. It should additionally be understood that the disclosure contemplates taking a plurality of biometric measurements of any biometric parameter now known to be measurable, or hereinafter capable of being measured, including scent, sound, gait, speech, appearance, and other parameters.

In accordance with a further embodiment of the disclosure, a physical device, for example a fob, card, token, dongle, or USB storage device, code device, may be used in combination with the BIO-PIN authentication disclosed herein.

FIG. 3 illustrates elements compared with a template by a computing device, including minutiae points such as ridge bifurcations 306, ridge endings 308, and a core 310, of the fingerprint area 302.

Authentication and security in accordance with the disclosure is useful, at least, in the fields of education, certification, licensure, banking, insurance, Internet purchasing, websites, on-line accounts, customs, security clearance, security entrances, and other known or hereinafter identified contexts in which authentication is useful or necessary.

In consideration of the practical limitations of current biometric readers, a level of 100% correct authentication cannot be achieved over numerous attempts. For example, hardware or software can fail to correctly interpret a presentation of the correct body part. Alternatively, the body part may have changed somewhat, producing a false reading at least occasionally. The extent to which a biometric reading indicates failure for a correct presentation is termed the False Rejection Rate (FRR), and indication of success for an incorrect presentation is termed the False Acceptance Rate (FAR).

In accordance with the disclosure, an FRR or FAR can be further be observed with respect to the order of presentation, or sequencing. For example, an authenticating individual may correctly recall an entire sequence (e.g. a sequence of fingers, face parts, or words), or only a portion of the sequence. This could be construed as a false rejection, although the individual has presented a certain amount, or perhaps most, of a correct sequence.

Accordingly, the disclosure provides a mechanism to enable the acceptance of a predetermined extent of FRR and FAR due to either failure to correctly interpret a biometric recognition (indicated with the variable R), or failure to present biometric input in the correct sequence (indicated with the variable S). The allowable extent of failure of R and S can be determined based upon historical observations of accuracy, a determination of accuracy, or a valuation of the credibility of each method of authentication. Moreover, the extent of failure for R and S can be determined by the developer of a BIO-PIN system, or can be configurable by an owner/operator of such a system based upon a level of security quality desired by the owner. Consideration can be given to the cost of higher quality. As a requirement for accuracy of R or S is increased, security is increased and FAR is reduced, but more user frustration emerges as FRR increases. The disclosure provides a method of balancing security and usability for the BIO-PIN authentication method.

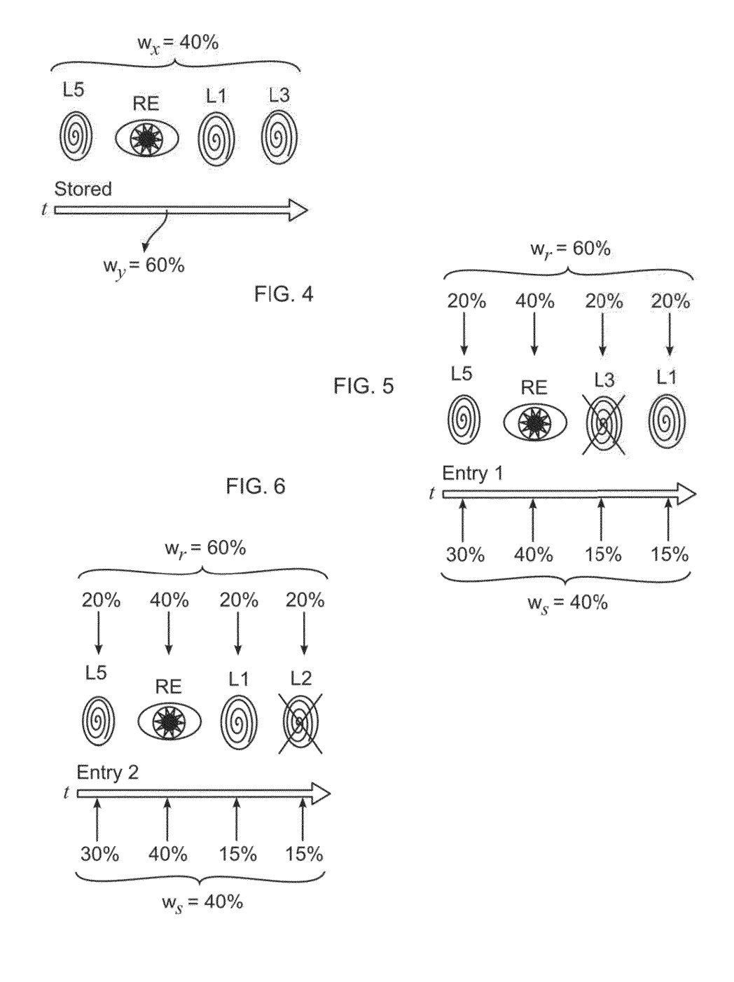

More particularly, and with reference to FIG. 4, a multi-factor multi-biometric authentication mechanism, or BIO-PIN, includes an exemplary ordered sequence of four body parts, including three fingerprints and an iris of an eye. In this embodiment, a weighting factor wᵣ is applied to results pertaining to recognition of the biometric pattern, here defined to include the stored samples of the fifth, first, and third fingers of the left hand, indicated as L5, L1, and L3, respectively, and the iris of the right eye, indicated as RE, of a person to be authenticated. In the example shown, a completely correct recognition of all biometric patterns is accorded a weighting factor of 40% of the value of a perfectly presented BIO-PIN sequence.

As further indicated in FIG. 4, a weighting factor wₛ is applied to results pertaining to submission of the biometric patterns in accordance with a stored sequence. In this example, a completely correct sequential presentation is accorded a weighting factor of 60% of the value of a perfectly presented BIO-PIN sequence. In this example, the extent of failure for R and S is determined by the developer of a BIO-PIN system or an owner/operator of such a system to exceed 80%.

The results of a BIO-PIN scan are evaluated in view of the foregoing, according to the formula:

R·wᵣ+S·wₛ>0.80|wᵣ=0.4;wₛ=0.6

Where wᵣ+wₛ≦1, and R corresponds to a total percentage value corresponding to correct biometric readings, and S corresponds to a total percentage value corresponding to elements presented in the correct sequence. It should be understood that the weighting may be equal, or weighted to provide greater value to a correct presentation sequence or correct biometric readings. Each biometric reading, or parameter presented in the correct sequence, may be assigned an equal weight, in which case the total percentage value is a sum of the percentages for each value. Alternatively, each biometric reading, or each item presented in the correct sequence can be assigned a predetermined weight.

As shown in FIG. 5, collective biometric recognition collective sequence value result weightings are shown, of 60% and 40%, respectively. In addition, each biometric recognition value, and each sequence item, is shown with a predetermined percentage weight. These individual weights may be used without applying the total weighting for either biometric parameters or sequences, or both.

In the example of FIG. 5, the stored sequence in FIG. 4 applies, and weights are applied to each of the overall biometric and sequence results, as well as to individual biometric and sequence results. The operator of this BIO-PIN system has further set a combination of R and S to exceed 80%, with R having a weight of 40%, and S having a weight of 60%. Users are successfully authenticated according to the formula described above.

In the example shown (Entry 1), it may be seen that the last two fingers, L3 and L1, are the correct fingers, but are presented in the wrong sequence. Additionally, L3 is not recognized. In this example, within the biometric parameters, correct recognition of the iris is assigned a weight of 40%, and each finger 20%. Within the sequence, correctly presenting the first item in sequence is assigned a weight of 30%, the second 40%, and the remaining two in sequence 15% each. The percentage values for correct items in each category are summed, then these totals have their respective overall weighting applied, as follows:

R=20%+40%+0% (erroneous reading)+20%=80%

S=30%+40%+0% (not in sequence)+0% (not in sequence)=70%

and

R·wᵣ+S·wₛ=(80%·60%)+(70%·40%)=48%+28%=76%

As 76% is less than the overall predetermined threshold of 80%, this user is Not Authenticated.

In the Example of FIG. 6 (Entry 2), the criteria is the same as for FIG. 5; however, all results match the stored pattern except for the last sequential value, in which the second finger of the left hand (L2) is presented, instead of the stored value of the third finger of the left hand (L3). The analysis is thus as follows:

R=20%+40%+20%+0% (erroneous reading)=80%

S=30%+40%+15%+0% (not in sequence)=85%

and

R·wᵣ+S·wₛ=(80%·60%)+(85%·40%)=48%+34%=82%

As 82% is greater than the overall predetermined threshold of 80%, this user is Authenticated. In the example of FIG. 6, if L2 had been read correctly, the result would be unchanged, as L2 is not a biometric parameter within the BIO-PIN stored sequence of FIG. 4.

It should be understood that in the examples of FIGS. 5 and 6, other biometric parameters than the ones illustrated may be read, and a greater or lesser number of readings in the sequence may be carried out. Further, other mathematical formulations may be applied to weight individual biometric and sequential entries, as well as overall entries for biometric and sequential entries. Similarly, the weightings applied below for collective as well as individual parameters or sequences, can be substantially different than the values presented in the examples, depending upon the desired accuracy of the result, the accuracy of the equipment, the patience of the user population, the value of the property to be protected, the accuracy of the equipment, computing time, economics, and other considerations.

Further, weights may be assigned to time intervals between presentation of body parts for authentication, the time intervals corresponding to a stored template of time intervals. Notwithstanding the foregoing, the disclosure provides a method of capturing multiple biometric parameters presented in an ordered sequence, and comparing not only the biometric parameters against a template of included biometric parameters, but also comparing the presentation sequence against a stored sequence. As such, an effective result is obtained regardless of whether weighting is applied.

In the foregoing examples, a linear algorithm is used, wherein the weights are combined linearly to determine an authentication result, wherein the values of R and S are used in a linear regression. In accordance with the disclosure, more advanced computational algorithms can be applied to produce a more optimal result. For example, a non-linear fusion of R and S which can produce a more accurate result includes the following examples:

S²R·wₛ²wᵣ+SR·wₛwᵣ²> . . .

or

S³·wₛ³+S²R·wₛ²wᵣ+SR²·wₛwᵣ²+R³·wᵣ³> . . .

Other non-linear classification techniques, including non-linear regression and approximation, can be used, including the use of a Multi-Criteria Decision Analysis (MCDA), examples of which may be found in Levy, 2006 (see references), a publication of an inventor herein, the classification techniques therein being incorporated herein by reference. It should be understood, however, that the simple non-linear algorithm of the examples is sufficiently accurate for real world applications, and that more sophisticated algorithms can be used if desired to further improve the authentication decision based on the BIO-PIN methodology considering the FRR and FAR, or fusion approach of the disclosure.

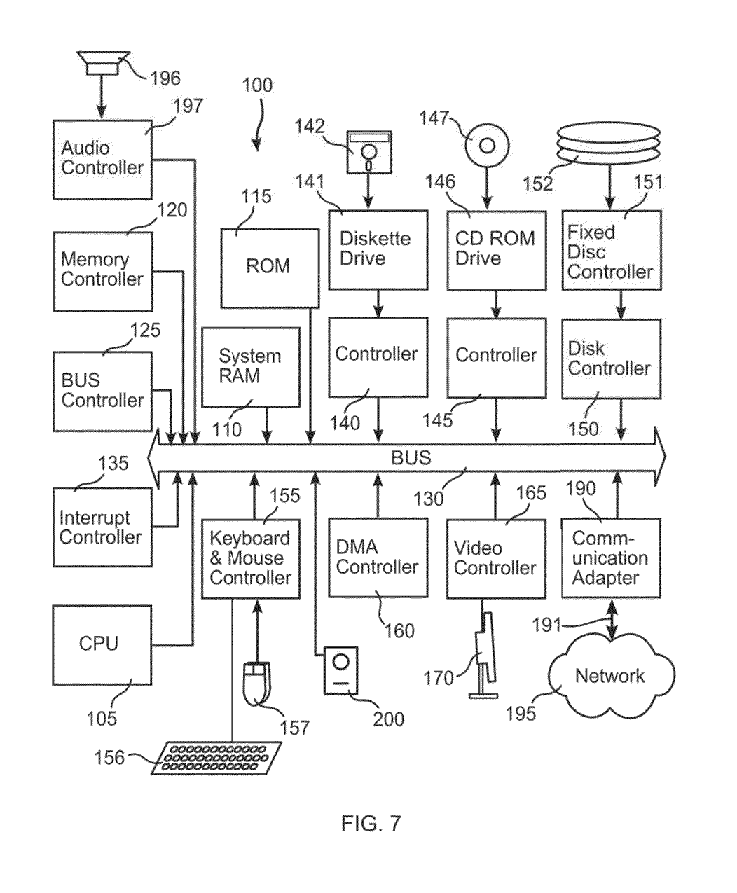

FIG. 7 illustrates the system architecture for a computer system 100 such as a server, work station or other processor on which, or with which, the disclosure may be implemented. The exemplary computer system of FIG. 7 is for descriptive purposes only. Although the description may refer to terms commonly used in describing particular computer systems, the description and concepts equally apply to other systems, including systems having architectures dissimilar to FIG. 3.

Computer system 100 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 100. A bus controller 125 is provided for controlling bus 130. An interrupt controller 135 is used for receiving and processing various interrupt signals from the system components.

Mass storage may be provided by diskette 142, CD or DVD ROM 147, flash or rotating hard disk drive 152. Data and software, including software 400 of the disclosure, may be exchanged with computer system 100 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150. It should be understood that other storage, peripheral, and computer processing means may be developed in the future, which may advantageously be used with the disclosure.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165, which controls video display 170. Computer system 100 also includes a communications adapter 190, which allows the system to be interconnected to a local area network (LAN) or a wide area network (WAN), schematically illustrated by bus 191 and network 195. The disclosure further contemplates that some or all components of computer system 100 may be embodied within a portable device, such as a pen and/or tablet, Personal Digital Assistant (PDA), mobile/cellular phone. One or more biometric reader 200, such as a fingerprint scanner, camera, or retinal scanner, for example, or any other device capable of gathering biometric data, is connected to bus 130. In the example shown, the connection is directly to bus 130, however it should be understood that reader 200 may be connected to an interface device, for example a USB port, or to keyboard & mouse controller 155, for example.

Operation of computer system 100 is generally controlled and coordinated by operating system software, such as a Linux (a trademark of Linus Torvalds, Finland), Mac OS (a trademark of Apple Computer, Inc. of California), or Windows (a trademark of Microsoft, Inc., of Washington) system. The operating system controls allocation of system resources and performs tasks such as processing scheduling, memory management, networking, and I/O services, among other things. In particular, an operating system resident in system memory and running on CPU 105 coordinates the operation of the other elements of computer system 100. The present disclosure may be implemented with any number of commercially available operating systems.

One or more applications, such as an HTML page server, or a commercially available communication application, may execute under the control of the operating system, operable to convey information to a user.

All references cited herein are expressly incorporated by reference in their entirety. It will be appreciated by persons skilled in the art that the present invention is not limited to what has been particularly shown and described herein above. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

### REFERENCES

Cavoukian, A. (2005), Identity Theft Revisited: Security is Not Enough. Toronto, Ontario, Canada: Retrieved from http://www.ipc.on.ca/English/Resources/Discussion-Papers/Discussion-Papers-Summary/?id=233
Common Methodology for Information Technology Security, Evaluation Biometric Evaluation Methodology (BEM) Supplement (2002). Common Criteria Biometric Evaluation Methodology Working Group, Version 1.0. Retrieved from http://www.cesg.gov.uk/policy_technologies/biometrics/rnedla/bem_{—}10.pdf
Dhamija, R., & Dusseault, L (2008). The seven laws of identity management usability and security challenges. IEEE Security & Privacy, 1540-7993/08/24-29.
Hisham A. A., Harin, S., & Sabah J. (2010). Multi-factor biometrics for authentication: A false sense of security. Department of Applied Computing, University of Buckingham, MK181EG, United Kingdom.
Levy, Y. (2006). Assessing the value of e-learning systems. Hershey, Pa.: Information Science Publishing. doi:10.4018/978-1-59140-726-3.
Maty'a's, V., R'iha, Z- (2010). Security of biometic authentication systems. Technical report. http://www.fi.muni.cz/reports/files/2010/F1MU-RS-2010-07.pdf.
Ross, A-A. (2007). An introduction to multi-biometrics. Proceedings of the 15th European Signal Processing Conference (EUSIPCO), Poznan, Poland, pp 20-24.
Ross, A. A., Nandakumar, K., & Jain, A. K. (2006). Handbook of multibiometrics. New York, N.Y.: Springer
Shenk, M. (2007). Who can you Trust, Computer Weekly, p28. Retrieved from http://connection.ebscohostcom/c/edltorials/25040622/who-can-you-trust.
Sun, Z., Paulino, A., Feng, J., Chal, Z., Tan, T., & Jain A., A. (2010). Study of multi-biometric traits of identical twins. In SPIE Biometric technology for human identification VII, Vol. 7667. Retrieved from http://www.citeulike.org/user/vipin255/article/8386459.
Vetter, R. (2010). Authentication by biometic verification, IEEE Computer Society, 43 (2), doi10.1109/MC.2010.31.
Zhang, D. D. (2004). Palmprint authentication. Norwell, M A: Kluwer Academic Publishers.

What is claimed is:

1. A method of authenticating a user, comprising:
using at least one computer and connected scanner to obtain biometric measurements of a plurality of biometric parameters of the user;
storing the biometric measurements upon computer readable media as templates for comparison;
storing upon computer readable media a sequence in which the plurality of biometric parameters are to be scanned in order to perform a valid authentication;
determine authentication of the user by using at least one computer to—
compare biometric parameters submitted with the stored biometric templates, to determine if biometric parameters match a stored template,
identify the sequence with which each biometric parameter was presented,
compare the sequence with the stored sequence, and
if biometric parameters match, and sequences match, authenticate the user.

2. The method of claim 1, wherein the biometric parameter is a finger or thumbprint.

3. The method of claim 1, wherein the biometric parameter includes a measurement of finger segments.

4. The method of claim 1, wherein the biometric parameter is a part of an eye.

5. A system of authenticating a user, comprising:
at least one computer connectable to a scanner configured to obtain biometric measurements of a plurality of biometric parameters of the user;
software executable from non-transitory media by said at least one computer operative to—
(a) store the biometric measurements upon computer readable media as templates for comparison;
(b) store upon computer readable media a sequence in which the plurality of biometric parameters are to be scanned in order to perform a valid authentication;
(c) determine authentication of the user by—
(i) comparing each biometric parameter submitted with the stored biometric templates, to determine which biometric parameter matches a stored template,
(ii) identifying the sequence with which each biometric parameter was presented,
(iii) comparing the sequence with the stored sequence, and
(iv) if biometric parameters match, and the sequences match, authenticate the user.

6. The method of claim 1, wherein the biometric parameter is a finger or thumbprint.

7. The method of claim 1, wherein the biometric parameter includes a measurement of finger segments.

8. The method of claim 1, wherein the biometric parameter is a part of an eye.

9. A method of authenticating a user, comprising:
using software executing upon at least one computer, the software stored on non-transitory media and configured to:
receive data pertaining to a plurality of biometric parameters each corresponding to a different body part of an individual to be authenticated;
receive template data pertaining to a selection of the plurality of biometric parameters for a user to be authenticated;
receive sequence data pertaining to a sequential order in which the selection of the plurality of biometric parameters are to be presented for authentication by the user;
receive biometric presentation data pertaining to biometric data corresponding to a plurality of body parts presented by the user during an attempt to authenticate the user;
receive sequence presentation data pertaining to a sequence in which the plurality of body parts were presented by the user;
compare the biometric data to the template data to determine presented body parts which match biometric parameters of the stored template;
compare the sequence presentation data to the sequence data to determine body parts presented in the sequential order of the sequence data; and
indicate authentication if the biometric data comparison and the sequence presentation comparison each include a predetermined quantity of matches.

10. The method of claim 1, wherein the biometric parameter is a finger or thumbprint.

11. The method of claim 1, wherein the biometric parameter includes a measurement of finger segments.

12. The method of claim 1, wherein the biometric parameter is a part of an eye.
